(19) United States
(12) Patent Application Publication
(10) Pub. No.: US 2009/0073715 A1
(43) Pub. Date: Mar. 19, 2009

(54) Light Emitting Unit and Illumination Device and Image Scanner Using Such Light Emitting Unit

(76) Inventors: Tomihisa Saito, Tokyo (JP); Hiroyuki Nemoto, Tokyo (JP); Hidemitsu Takeuchi, Tokyo (JP); Takashi Kishimoto, Tokyo (JP); Naofumi Sumitani, Tokushima (JP)

Correspondence Address: CARRIER BLACKMAN AND ASSOCIATES, 24101 NOVI ROAD, SUITE 100, NOVI, MI, 48375, US

(21) Appl. No.: 11/887,878

(22) PCT Filed: Apr. 3, 2006
(86) PCT No.: PCT/JP2006/307028

§ 371 Date: Jun. 2, 2008

(30) Foreign Application Priority Data
Apr. 4, 2005 (JP) 2005-107062
Mar. 15, 2006 (JP) 2006-071379

(51) Int. Cl. G02B 6/00; F21V 15/01

(52) U.S. Cl. 362/551; 362/362

(57) ABSTRACT

A light emitting unit comprises a light emitting element, a light emitting element substrate for mounting the light emitting element, and a light emitting element substrate frame member provided with a window for exposing the light emitting element, wherein the inside of the window is sealed with a first resin and a second resin, the ratio of the second resin relative to the first resin becomes smaller toward the outside of the window from the inside thereof. The first resin is a transparent resin, and the second resin is a colored resin with a high color value or a resin including a light reflective material and/or a light scattering material. Since a sectional border line between the first resin and the second resin is a curved line, the light reflected from the bottom section of the window among the light emitted from the light emitting element can also be efficiently emitted to the outside.

### BACKGROUND OF THE INVENTION

1. Field of the Invention

The present invention relates to a light emitting unit, a light emitting device and a line illumination device used in illumination, an automobile, industrial equipment and general consumer equipment in which this light emitting unit is incorporated, and an image scanner in which this line illumination device is incorporated.

2. Description of the Prior Art

An image sensor is incorporated in an image scanner, for scanning a document, such as a facsimile machine, a copying machine and an image scanner device. The image sensor may be a contact-type or a reduction-type, but each image sensor type is provided with a line illumination device for linearly illuminating a document surface along the main scanning range.

The line illumination device using a light guide is known. For example, Japanese Patent Application Publication No. H08-163320 and Japanese Patent Application Publication No. H10-126581 (Japanese Patent No. 2999431) disclose a line illumination device using a bar-shaped or plate-shaped light guide, and an image scanner using the line illumination device.

The line illumination device is composed of a light guide adapted to cause the light incoming from an end face to be emitted from a light emitting surface provided along the longitudinal direction while causing the light to reflect on the inner surface, and a light emitting unit provided on the end surface side of the light guide. For example, as described in Japanese Patent Application Publication No. 2003-023525, a light emitting unit is provided in such a manner that a light emitting element substrate frame member 21 made of resin, in which lead frames 22 are disposed, is provided with a window 21a of a rectangular shape for mounting light emitting elements 23a, 23b and 23c. The lead frame 22 is provided with lead terminal sections 22a, each serving as an external connection terminal, internal lead sections 22c, and light emitting element mounting and connecting sections 22b exposed within the window 21a, wherein the light emitting elements 23a, 23b and 23c adhere to the lead frames 22 exposed within the window 21a, electrodes of the light emitting elements 23a, 23b and 23c are connected to the lead frames 22 by metal wires, and the window 21a is then sealed with transparent resin.

Japanese Patent Application Publication No. H11-136449 (Japanese Patent No. 3101240) discloses a light emitting unit which is provided with a surface tapered at a predetermined angle so that a side wall surface of a window expands toward the surface of a light emitting element substrate frame member from a light emitting element mounting section.

FIGS. 15 and 16 are a cross sectional view and a top view showing a window of a conventional light emitting unit. FIG. 15 is a cross sectional view taken along line C-C of FIG. 16. A light emitting element 23 is connected to an electrode by a metal wire 24. The inside of the window is sealed with a transparent resin 25. Light emitting elements 23a, 23b and 23c emit red, green and blue colors, respectively. Arrows in FIG. 15 indicate emitted lights from the light emitting element. Since it is difficult for the light emitted in the lateral direction to be emitted outside the window compared to the light emitted toward the upper section of the window, the emitted light cannot be efficiently used.

FIG. 17 is a cross sectional view showing another example of a window of a conventional light emitting unit. Since the cross section of the window is formed in a trapezoidal shape of which the emission (outgoing) side is wide, even the light reflected in the lateral direction can be efficiently emitted. However, since it is difficult for the light at the bottom section of the window to be reflected, all the emitted light from the light emitting element cannot be effectively used.

[Patent Document 1] Japanese Patent Application Publication No. H08-163320

[Patent Document 2] Japanese Patent Application Publication No. H10-126581

[Patent Document 3] Japanese Patent Application Publication No. 2003-23525

[Patent Document 4] Japanese Patent Application Publication No. H11-136449

In the case where a side wall surface of a window is made vertical (perpendicular) as shown in FIG. 15, there is a problem in which the light emitted in the lateral direction of (among) the light emitted from the light emitting element cannot be effectively utilized. On the other hand, in the case where the side wall surface of the window is provided to form a taper surface inclined at a predetermined angle so that the wall surface expands toward the light emitting surface of the light emitting unit, the light emitted in the lateral direction can also be effectively utilized. However, there is a problem in which the light is not always effectively and sufficiently utilized because the light reflection is not readily caused in the vicinity of the bottom section of the side wall.

Further, in order to improve the illumination efficiency or for the design reason of the image scanner, there is a case where a light guide of which the width of the light emitting surface in the sub-scanning direction is narrowed is used, but for the design limitation and the like, there is a case where a cross sectional area of the incident end surface of the light guide must also be narrowed to narrow the width of the light emitting surface. In the case where the cross sectional area of the incident end surface of the light guide is narrowed, there is a case where the area of the incident end surface of the light guide is smaller than the size of the window. In this case, there is a problem in which the light gets out of a gap section to lower the illumination intensity.

In order to increase the light emission amount of the light emitting element, an attempt to make the light emitting element large has been recently made. It is necessary to design the window section widely in accordance with the tendency toward enlargement of the light emitting element. However, when the window section is broadened, there is a problem in which the window section becomes larger than the incident end surface of the light guide and the light gets out of the gap.

### SUMMARY OF THE INVENTION

To solve the problems described above, a light emitting unit according to the present invention is provided, which comprises a light emitting element, a light emitting element substrate for mounting the light emitting element, and a light emitting element substrate frame member provided with a window for exposing the light emitting element, wherein the inside of the window is sealed with a first resin and a second resin, and the ratio of the second resin relative to the first resin is smaller toward the outside of the window from the inside thereof. The first resin is a transparent resin, while the second resin is a colored resin of a high color value or a resin containing a light reflective material and/or a light scattering material. It is desirable that the cross sectional border line between the first resin and the second resin be a curved line. It is also desirable that the cross sectional of the window be formed in a rectangular shape or in a trapezoidal shape in which the opening side is narrow.

An illumination device using the light emitting unit according to the present invention is provided, in which the light incoming from the light emitting unit provided on an end surface side of a bar-shaped light guide in the longitudinal direction is emitted from a light emitting surface provided along the longitudinal direction while the light is reflected from the inner surface of the bar-shaped light guide. It is desirable that the cross sectional area of the end surface of the bar-shaper light guide on the incident side be smaller than an area of the bottom section of the window.

An illumination device using the light emitting unit according to the present invention is provided, in which the light incoming from the light emitting unit provided on a side surface of a plate-shaped light guide in the thickness direction is emitted form the upper surface or the lower surface of the plate-shaped light guide while the light is reflected from the inner surface of the plate-shape light guide.

The present not only includes an image sensor in which the illumination device, a line image sensor, and an optical system for converging the reflected light or the transmitted light from a document are incorporated in a casing, but also an image scanner in which the image sensor is incorporated.

### BRIEF DESCRIPTION OF THE DRAWINGS

The above and other objects, features and advantages of the present invention will become more apparent from the following description when taken in conjunction with the accompanying drawings.

FIG. 1 is a cross sectional view of a contact image sensor in which a line illumination device according to the present invention is incorporated;

FIG. 2 is an exploded perspective view of the line illumination device;

FIG. 3 is a perspective view showing one example of light scattering patterns formed on the reverse side of a light guide;

FIG. 4 is a front view of a light emitting unit;

FIG. 5 is a sectional side view of the light emitting unit;

FIG. 6 is a perspective view showing the structure of a lead frame of the light emitting unit;

FIG. 7 is a cross sectional view showing another embodiment of the contact image sensor;

FIG. 8 is an exploded perspective view of an illumination device incorporated in the contact image sensor of FIG. 7;

FIG. 9 is a pattern diagram showing the structure of a reduction-type image sensor;

FIG. 10 is a cross sectional view showing an embodiment of a window of the light emitting unit according to the present invention;

FIG. 11 is a cross sectional view showing another embodiment of the window of the light emitting unit according to the present invention;

FIG. 12 is a cross sectional view showing still another embodiment of the window of the light emitting unit according to the present invention;

FIG. 13 (A) is a cross sectional view showing still further embodiment of the window of the light emitting unit according to the present invention, FIG. 13 (B) is a perspective view of an illumination device using the light emitting unit of the present invention;

FIG. 14 is a top view of a window section of the light emitting unit according to the present invention;

FIG. 15 is a cross sectional view of a window section of a conventional light emitting unit;

FIG. 16 is a top view of the window section of the conventional light emitting unit; and

FIG. 17 is a cross sectional view of a window section of the conventional light emitting unit.

### DETAILED DESCRIPTION OF THE PREFERRED EMBODIMENTS

Preferred embodiments of the present invention will now be described with reference to the accompanying drawings.

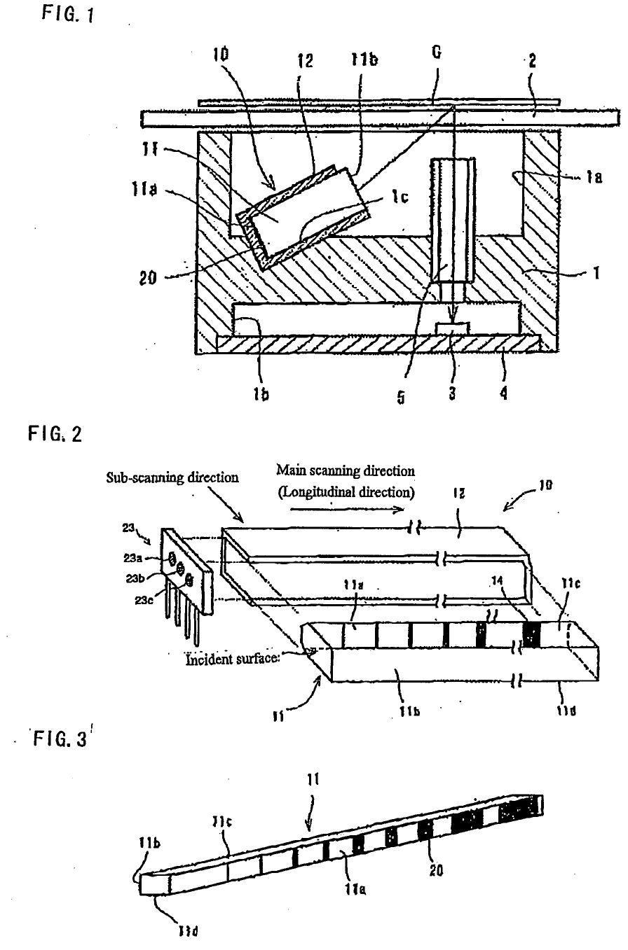

FIG. 1 is a cross sectional view of an image scanner in which a line illumination device is incorporated and FIG. 2 is an exploded perspective view of the line illumination device. FIG. 3 is a perspective view showing one example of light scattering patterns formed on the reverse side of a light guide.

As shown in FIG. 1, an image scanner comprises an image sensor, a glass plate, and a casing adapted to house the image sensor and the glass plate therein. Referring to the image sensor, a frame 1 of the image sensor is provided with depressions 1a, 1b and 1c, wherein a line illumination device 10 is disposed in the depression 1c and a sensor substrate 4 provided with a photoelectric conversion element array 3 is installed in the depression 1b. A rod lens array 5 for 1:1 imaging is retained within the frame 1. A glass plate 2 is provided above the frame 1. The light emitted from a light emitting surface 11b of the line illumination device 10 is applied to a document G through the glass plate 2. The reflected light from the document G is detected by the photoelectric conversion element array 3 through the lens array 5 of an erecting 1:1 imaging system (an erecting unit magnification imaging system) to scan the document G. A rod lens array, a flat plate type micro lens array and the like can be used as the erecting 1:1 imaging system. A desired area of the document G is scanned by moving the frame 1 of the image sensor in the sub-scanning direction of FIG. 2 relative to the glass plate 2.

As shown in FIG. 2, the line illumination device 10 is provided in such a manner that a light guide 11 is installed in a white light guide casing 12 to expose the light emitting surface 11b, and a light emitting unit provided with one or more light emitting elements (e.g., light emitting diodes) 23 as a light source is attached to one end of the light guide casing 12. The light guide 11 is composed of a translucent material such as glass and acrylic. The basic cross sectional shape of the light guide 11 in the direction perpendicular to the main scanning direction (i.e., the longitudinal direction) is made rectangular, wherein an angulation (corner) section between a surface 11a where scattering patterns are provided and a side surface 11c and an angulation section between the surface 11a and a surface 11d are chamfered in a C-shape.

As shown in FIG. 3, light scattering patterns 20 for scattering the light from a light source incoming from the incident surface are formed on the reverse side of the light guide 11 by screen printing of white paints, formation of a projection and a depression, and the like.

The line illumination device 10 introduces the light from the light source into the light guide 11 from one end (incidence surface) of the light guide 11, scatters the light propagating within the light guide 11 by the light scattering patterns formed on the reverse side of the light guide 11, and emits the scattered light from the light emitting surface 11b.

The intensity of light incoming from the light source is large on the side near the incident surface and becomes smaller as the distance from the incident surface increases. As shown in FIG. 3, the light emitting from the light emitting surface 11b is made uniform over the whole length of the main scanning direction by broadening a formation area of the light scattering patterns as the distance from the incident surface increases.

As shown in FIGS. 1 and 2, the light guide 11 is covered by the light guide casing 12 for protection. With this arrangement, it is possible to prevent the scattered light from being uselessly emitted outside the light guide and to increase the intensity of the emitted light.

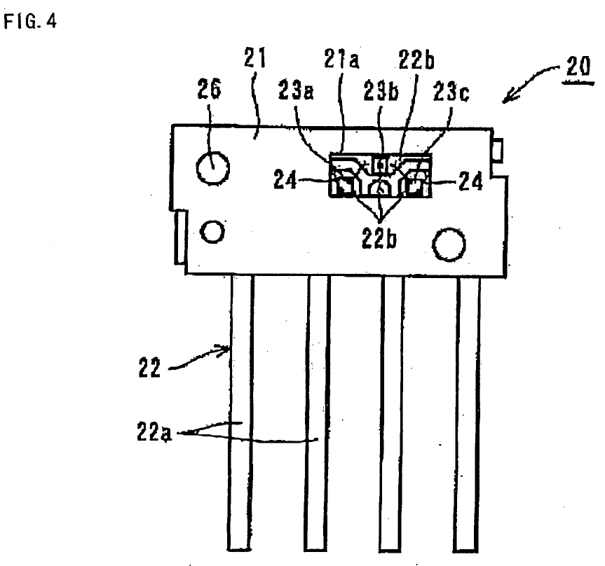

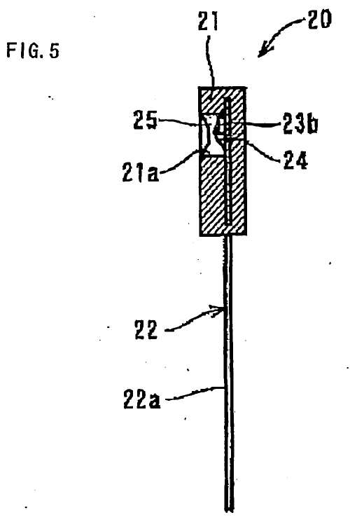

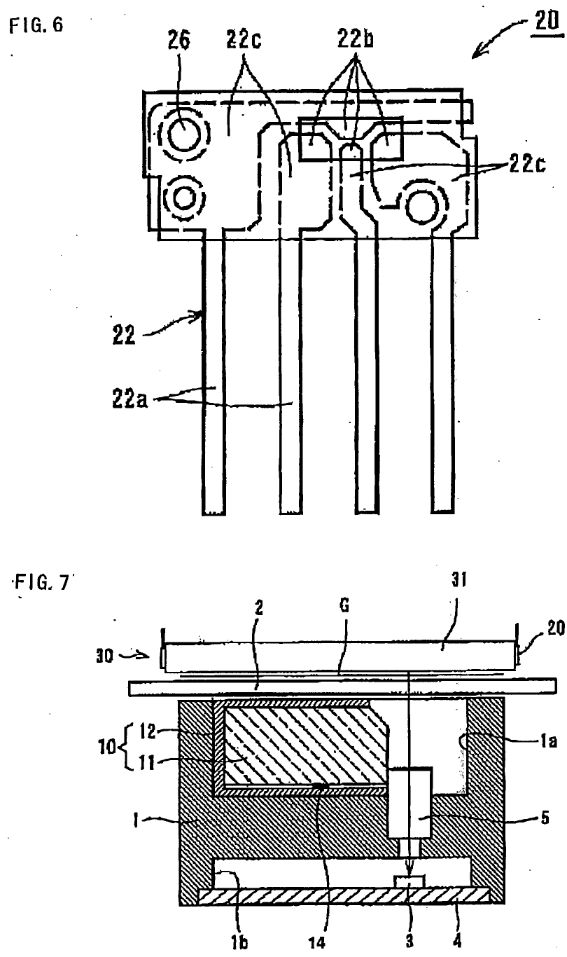

FIG. 4 is a front view of a light emitting unit and FIG. 5 is a sectional side view of the light emitting unit. FIG. 6 is a perspective view showing the structure of a lead frame of the light emitting unit.

A light emitting element substrate frame member 21 is made by insert molding a lead frame 22 into a substrate resin and is provided with a window 21a for mounting light emitting elements 23 (23a, 23b and 23c). The lead frame 22 consists of an exposed section (i.e., a lead terminal section) 22a for supplying electricity to the light emitting elements 23 from outside, a section exposed within the window 21a for mounting the light emitting elements 23 (i.e., a light emitting element mounting and connecting section) 22b, and a section concealed within the substrate resin (i.e., an inner lead section). The surface of the lead frame 22 is silver plated to make the light reflection factor large and to improve the wire bonding performance.

A light emitting unit 20 is provided in such a manner that light emitting elements 23 (23a, 23b and 23c) are adhered onto the lead frame 22b exposed within the window 21a of the light emitting element substrate frame member 21, the light emitting elements 23 (23a, 23b and 23c) and the lead frame 22b are connected by metal wires 24, and these are sealed with a transparent resin. A through-bore 26 provided on the light emitting element substrate frame member 21 is used to secure the light emitting unit 20 to the light guide casing 12 when the line illumination device is assembled.

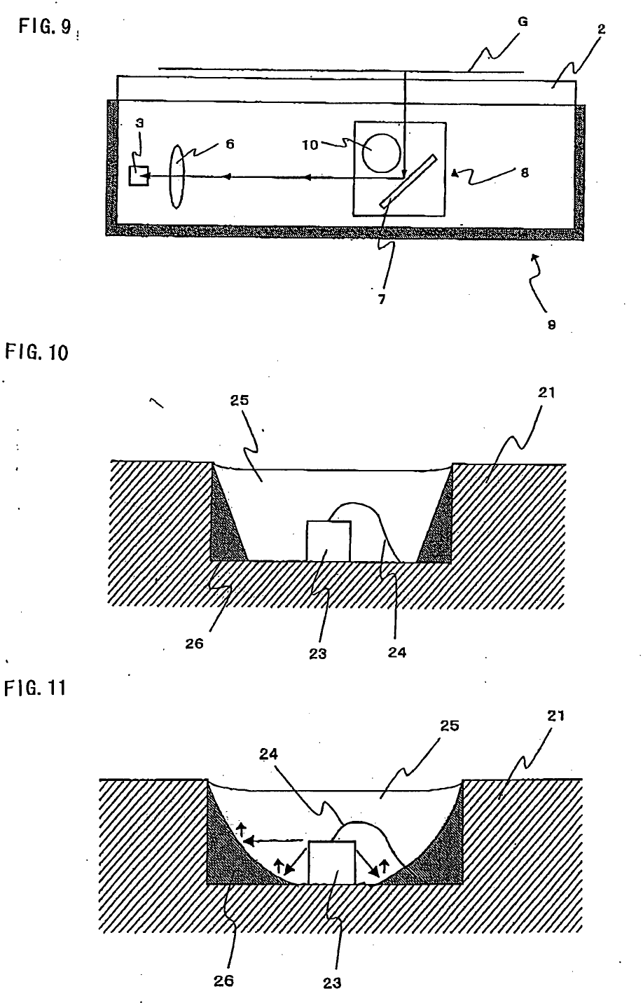

FIG. 10 is a cross sectional view of the window. The light emitting element 23 is connected to an electrode by a metal wire 24 and the window section is formed in a rectangular shape. The inside of the window is filled with a first resin 25 and a second resin 26. The area ratio of the cross section of the second resin 26 relative to the first resin 25 is made smaller toward the upper section of the window. The first resin 25 is a transparent resin for transmitting the light emitted from the light emitting element 23. The second resin is a colored resin of a high color value for reflecting and scattering the light and preferably is a white resin. A silicone resin is available as the second resin. A transparent resin and the like containing light reflective material/scattering material can also be used for the second resin.

It is to be noted that the first resin 25 and the second resin 26a may contain a fluorescent material of which the wave length can be changed by the light from the light emitting element mounted according to the present invention. Such a fluorescent material includes the followings:

(Fluorescent Materials)

Fluorescent materials can be those which absorb the light from a semiconductor light emitting element chip and convert it to the light with a different wave length. For example, it is desirable that the fluorescent material be at least one or more materials selected from: a nitride fluorescent substance and a oxynitride fluorescent substance mainly activated by a lanthanide elements such as Eu and Ce, an alkaline earth halogen apatite fluorescent substance activated by elements of a lanthanide such as Eu and of a transition metal such as Mn, an alkaline earth metal boric acid halogen fluorescent substance, an alkaline earth metal aluminate fluorescent substance, an alkaline earth silicate, an alkaline earth sulfide fluorescent substance, an alkaline earth thiogallates, an alkaline earth silicon nitride, a Germania, or a rare earth aluminate fluorescent substance mainly activated by a lanthanide element such as Ce, a rare earth silicate, or an organic body and an organic complex mainly activated by a lanthanide element such as Eu. The concrete examples of fluorescent substances to be used are shown below, but the fluorescent substances are not limited to them.

The nitride fluorescent substance activated mainly by the lanthanide elements such as Eu and Ce include M₂Si₅N₈:Eu (M is at least one or more selected from Sr, Ca, Ba, Mg and Zn). In addition to M₂Si₅N₈:Eu, MSi₇N₁₀:Eu, M_{1.8}Si₅O_{0.2}N₈:Eu, and M_{0.9}Si₇O_{0.1}N₁₀:Eu (M is at least one or more selected from Sr, Ca, Ba, Mg and Zn) are also available.

The oxynitride fluorescent substance activated mainly by the lanthanide elements such as Eu and Ce includes Msi₂O₂N₂:Eu (M is at least one or more selected from Sr, Ca, Ba, Mg and Zn).

The alkaline earth halogen apatite fluorescent substance activated mainly by the lanthanide element such as Eu and the transition metal element such as Mn includes M₅(PO₄)₃X:R (M is at least one or more selected from Sr, Ca, Ba, Mg and Zn. X is at least one or more selected from F Cl, Br, and I. R is one or more of Eu, Mn, Eu and Mn).

The alkaline earth metal boric acid halogen fluorescent substance includes M₂B₅O₉X:R (M is at least one or more selected from Sr, Ca, Ba, Mg and Zn. X is at least one or more selected from F, Cl, Br and U. R is one or more of Eu, Mn, and Eu and Mn).

The alkaline earth metal aluminate fluorescent substance includes SrAl₂O₄:R, Sr₄Al₁₄O₂₅:R, CaAl₂O₄:R, BaMg₂Al₁₆O₂₇:R, BaMg₂Al₁₆O₁₂:R and BaMgAl₁₀O₁₇:R (R is one or more of Eu, Mn, and Eu and Mn).

The alkaline earth metal sulfide fluorescent substance includes La₂O₂S:Eu, Y₂O₂S:Eu and Gd₂O₂S:Eu.

The rare earth aluminate fluorescent substance activated mainly by the lanthanide element such as Ce also includes YAG fluorescent substance expressed by a composition formula of Y₃Al₅O₁₂:Ce, (Y_{0.8}Gd_{0.2})₃Al₅O₁₂:Ce, Y₃(Al_{0.8}Ga_{0.2})₅O₁₂:Ce, Y, Gd)₃(Al, Ga)₅O₁₂. The composition formula of Tb₃Al₅O₁₂:Ce and Lu₃Al₅O₁₂:Ce is also available in which Tb and Lu are substituted for part or all of Y.

Other fluorescent substance includes ZnS:Eu, Zn₂GeO₄:Mn and MGa₂S₄:Eu (M is at least one or more selected from Sr, Ca, Ba, Mg and Zn. X is at least one more selected from F, Cl, Br and I).

The above fluorescent substance can also include one or more selected from Tb, Cu, Ag, Au, Cr, Nd, Dy, Co, Ni, and Ti in place of Eu or in addition to Eu, if necessary.

A fluorescent substance other than that described above can also be used if it has the same performance and effect. In these fluorescent substances, it is possible to use not only a fluorescent substance having an emission spectrum for yellow, red, green and blue by an excitation light of the semiconductor light emitting element chip, but also a fluorescent substance having an emission spectrum for yellow, blue-green, orange which are neutral colors. In this manner, light emitting devices with various light emitting colors can be produced by using these fluorescent substances in combination.

For example, by using a GaN compound semiconductor light emitting element chip adapted to emit a blue color, the light is illuminated onto a YAG fluorescent substance of Y₃Al₅O₁₂:Ce or (Y_{0.8}Gd_{0.2})₃Al₅O₁₂:Ce to conduct a wave length conversion. In this manner, it is possible to provide a light emitting device emitting a white color by a combination color of the light from the semiconductor light emitting element chip with the light from the YAG fluorescent substance.

For example, by using the GaN compound semiconductor light emitting element chip having a peak wave length in a ultraviolet region, the light is illuminated onto and is caused to absorb by the fluorescent substances consisting of CaSi₂O₂N₂:Eu or SrSi₂O₂N₂:Eu emitting a green light through a yellow light, (Sr, Ca)₅(PO₄)₃Cl:Eu emitting a blue color which is a fluorescent substance, (Ca, Sr)₂Si₅N₈:Eu emitting a red color is illuminated and caused to absorb the light. With this, it is possible to provide a light emitting device which emits a white color with good color rending properties. Since the red, blue and green colors which are three primary colors are used, it is possible to realize a desired white color only by changing the compounding ratio of the fluorescent substances.

FIG. 11 is a cross sectional view of a window showing another embodiment. A second resin is provided in the immediate vicinity of a light emitting element 23 to cover a wire 24 of the light emitting element 23. In this manner, since an area of the bottom section of the window can be made smaller, almost all the light emitted from the light emitting element can be reflected from a side wall section composed of the second resin to emit it to the outside of the window. As shown in FIG. 11, if the sectional border line between the first resin and the second resin is a curved line, the light in the vicinity of the bottom surface can be more easily emitted to the upper section of the window.

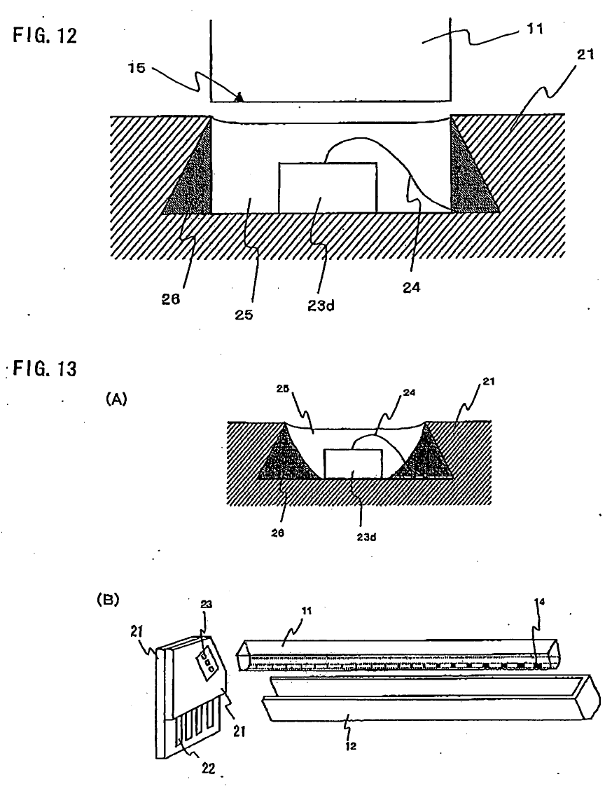

FIG. 12 is a cross sectional view of the window showing still another embodiment. A large light emitting element 23d is a light emitting element of which the size is larger than a conventional light emitting element. Thus, the window is made larger than a conventional window and an area of the bottom section of the window is larger than an incident end surface 15 of the light guide. To substantially match the size of the light incident end surface 15 of the light guide with that of the upper opening section of the window, the side wall section of the window is provided to form a reverse taper surface so that the opening section becomes smaller toward the upper section of the window. In the case where the side wall surface is made reverse taper, the inner light cannot be efficiently emitted to the outside. Accordingly, the second resin 26 is filled to at least make areas of the upper section and the bottom section of the window equal.

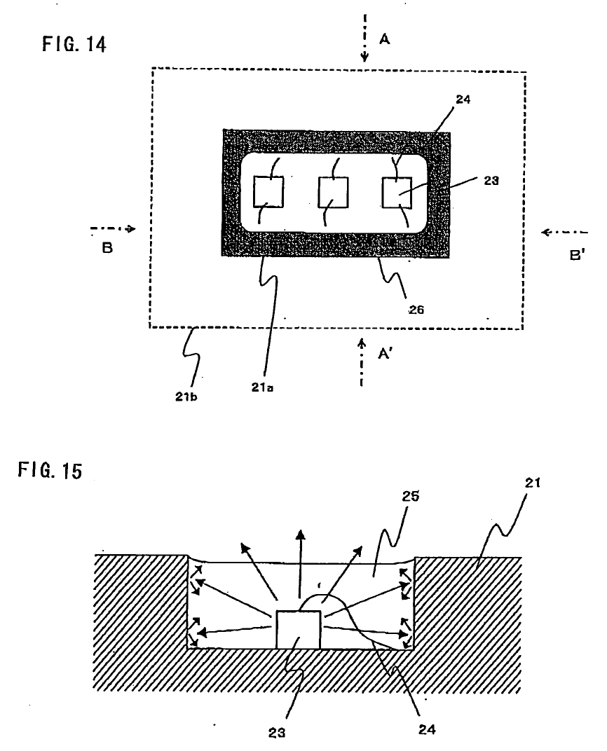

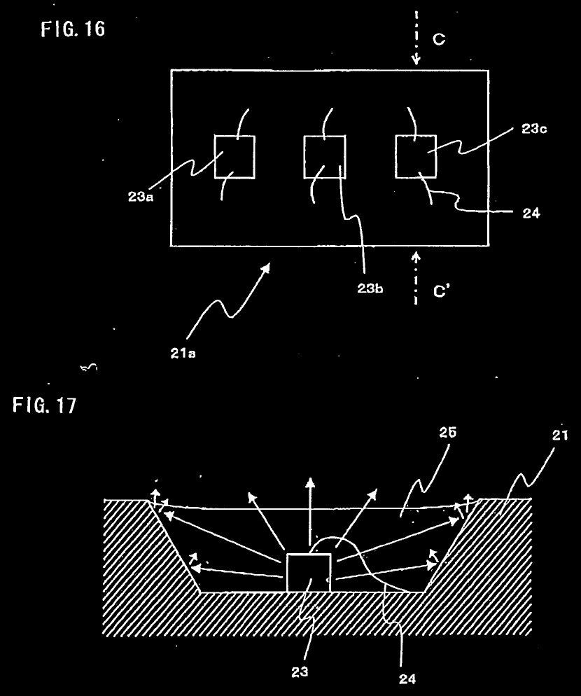

FIG. 13 (A) is a cross sectional view showing another embodiment using a large light emitting element. The second resin is filled until a position to cover the wire 24 in the same manner as in FIG. 12. Since the sectional border line between the first resin 25 and the second resin 26 is a curved line, the light of the bottom section of the window can also be reflected from the side wall section and the light can be efficiently emitted. FIG. 13 (B) is a perspective view of an illumination device using a large emitting unit. FIG. 14 is a top view of the window of FIG. 13 (A) as seen from the upper section of the window. FIGS. 10 through 13 (A) are cross sectional views taken along line A-A′ of FIG. 14. The cross section taken along line B-B′ also has the same shape.

The first resin and the second resin can be filled within a window of a light emitting element substrate frame member which has been already molded or the second resin can be molded separately from the light emitting element substrate frame member. In other words, by molding the second resin in advance in a shape to be fitted into the window, the molded second resin can be incorporated into the inside of the window. The second resin can be incorporated by a concavo-convex fitting method or by a method using an adhesive agent.

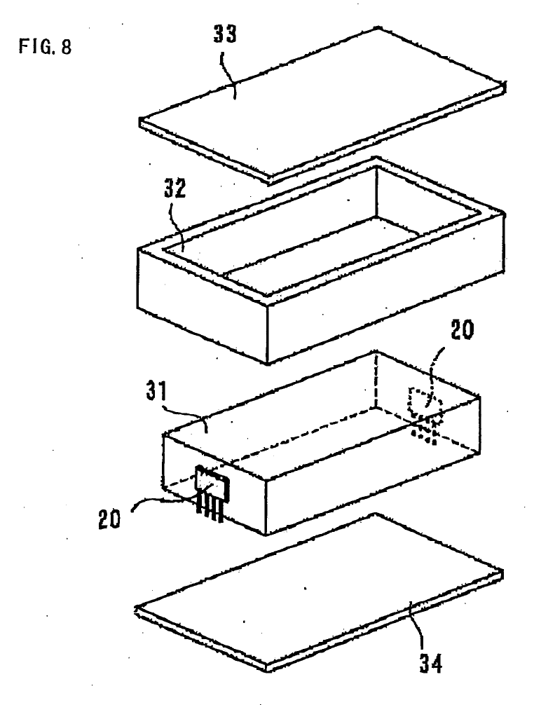

FIG. 7 is a cross sectional view showing another embodiment of an image scanner and FIG. 8 is an exploded perspective view of an illumination device which is incorporated in FIG. 7. In the image scanner as shown in FIG. 7, the reflected light from a document G is detected by a photoelectric conversion element 3 through a lens array 5 to scan the document G. In this embodiment, in addition to the functions described above, an illumination device 30 can also be disposed on an OHP document G and the like to scan the transmitted light of the document G using the photoelectric conversion element 3. These embodiments are also provided, in the same manner as in the image scanner of FIG. 1, to move a frame 1 relative to a glass plate 2 to scan a desired area of the document G.

The illumination device 30 is provided in such a manner that the light emitting unit 20 is attached in the thickness direction to the side surface of a plate-shape light guide 31 made of transparent acrylic resin, the plate-shaped light guide 31 is housed within a white casing 32, the upper surface serving as the reflection surface is provided with a white light reflector 33, and the lower surface serving as the light emitting surface is provided with a diffusion sheet 34.

The above description refers to the embodiments in a contact-type image sensor, but the illumination device according to the present invention can also be applied to a reduction-type image sensor. As shown in FIG. 9, in an image scanner 9 in which a reduction-type image sensor 8 is employed, a document placed on a transparent document table, such as a glass, is illuminated by an illumination device 10, the light reflected from the document surface is caused to reflect by a mirror 7 to be converged by a lens 6, so that the light is detected by a photoelectric conversion element 3. In the reduction-type image sensor, there is a case where the term “image sensor section” refers only to the photoelectric conversion element 3. However, the image sensor in the present specification is a section composed of an illumination device, a mirror, a photoelectric conversion element and a lens.

### EFFECTS OF THE INVENTION

According to the present invention, the ratio between a first resin and a second resin becomes smaller toward the outside of the window from the inside thereof. In this manner, it is possible to readily bring out the light from the light emitting element and to effectively use the light while making the area of the window section.

According to the present invention, design change of the side wall surface can be made without difficulty because the side wall surface of the window is formed to be inclined toward the outside by the first resin and the second resin.

According to the present invention, it is possible to efficiently distribute the light from the light emitting element and to increase the light emission amount because a sectional border line between the first resin and the second resin is a curved line.

According to the present invention, it is possible to cause all the light to enter the light guide even though the light emitting element substrate having a large light emitting element is used because the cross sectional shape of the window is formed in a narrow trapezoidal shape on the opening side.

By using the light emitting unit of the present invention, it is possible to provide an illumination device with a large light emission amount.

1. A light emitting unit comprising: a light emitting element; a light emitting element substrate for mounting the light emitting element; and a light emitting element substrate frame member provided with a window for exposing the light emitting element; wherein an inside of the window is sealed with a first resin and a second resin, and a ratio of the second resin relative to the first resin becomes smaller toward the outside of the window from the inside of the window.

2. The light emitting unit according to claim 1, wherein the first resin is a transparent resin and the second resin is a colored resin of a high color value.

3. The light emitting unit according to claim 1, wherein the first resin is a transparent resin and the second resin is a resin containing a light reflection and/or scattering material.

4. The light emitting unit according to claim 1, wherein a sectional border line between the first resin and the second resin is a curved line.

5. The light emitting unit according to claim 1, wherein a cross section shape of the window is a rectangular shape.

6. The light emitting unit according to claim 1, wherein a cross sectional shape of the widow is a trapezoidal shape of which the opening side is narrow.

7. An illumination device comprising the light emitting unit according to claim 1 provided on an end surface side of a bar-shaped light guide in the longitudinal direction, wherein light incoming from the light emitting unit is emitted from a light emitting surface provided in the longitudinal direction while the light is reflected onto the inner surface of the bar-shaped light guide.

8. The illumination device according to claim 7, wherein a cross sectional area of the end surface of the bar-shaped light guide on an incident side is smaller than an area of a bottom surface of the window.

9. An illumination device comprising the light emitting unit according to claim 1 provided on a side surface of a plate-shaped light guide in the thickness direction is emitted from the upper surface or the lower surface of the plate-shaped light guide while the light is reflected onto the inner surface of the plate-shaped light guide.

10. An image sensor comprising: a casing together with the illumination device according to claim 7, a photoelectric conversion element array, and an optical system for converging the reflected light or the transmitted light from a document onto the photoelectric conversion element array incorporated in the casing.

11. An image scanner comprising the image sensor according to claim 10.

12. An image scanner comprising an image sensor, a transparent body for mounting a document, and an illumination device according to claim 9 provided above the transparent body.
